(19) United States
(12) Patent Application Publication
(10) Pub. No.: US 2025/0256360 A1
(43) Pub. Date: Aug. 14, 2025

(54) METHOD OF PROCESSING METAL ALLOYS

(71) Applicant: The Regents of the University of Michigan, Ann Arbor, MI (US)

(72) Inventors: Alan TAUB, West Bloomfield, MI (US); Jonathan GOETTSCH, Saginaw, MI (US)

(21) Appl. No.: 19/049,622

(22) Filed: Feb. 10, 2025

Related U.S. Application Data
(60) Provisional application No. 63/552,023, filed on Feb. 9, 2024.

(51) Int. Cl. B23K 35/28

(52) U.S. Cl. CPC B23K 35/286

(57) ABSTRACT

A metal alloy is produced by flowing an electric current through a molten mixture before the mixture solidifies. The flow of electric current has a maximum power density of less than 1 W/cm², less than 0.1 W/cm², or even less than 0.01 W/cm² and results in a refined microstructure having average features sizes less than those of the same alloy when conventionally produced in the absence of electric current. Application of the electric current at these exceptionally low power densities can be timed to ensure that the electric current is present at the beginning of and/or during the nucleation stage of alloy phase growth, which can maximize the refining effects of the electric current and/or minimize the duration of the electric current. The molten mixture can be formed in an electrode-equipped container, as a weld pool when welding metal materials together, or by remelting an already formed metal alloy.

### STATEMENT OF FEDERALLY SPONSORED RESEARCH

This invention was made with government support under 1762657 awarded by the National Science Foundation. The government has certain rights in the invention.

### TECHNICAL FIELD

This disclosure is related to metal alloys and methods of processing them.

### BACKGROUND

Metal alloys may be multi-phase systems including a matrix phase and one or more precipitate phase distributed within and throughout the matrix phase. In some cases, the precipitate phase is provided to improve the properties of the alloy relative to the matrix material alone. But the improvements depend on the size, distribution, and bonding with the matrix material. For example, if the particle size of the precipitate phase is too large, it may function more as a contaminant than as a property enhancer.

### SUMMARY

Embodiments of a method of processing a metal alloy include flowing an electric current through a molten mixture comprising elements of the metal alloy before the molten mixture solidifies to form the metal alloy. The flow of electric current has a maximum power density less than 1 W/cm².

The method may further include any technically feasible combination of the following features:
the metal alloy is a multiphase alloy having a plurality of chemically distinct phases, and the step of flowing is performed during formation of the phases;
the metal alloy is a multiphase alloy having a plurality of chemically distinct phases, and the step of flowing is performed before formation of the phases and continues during formation of the phases;
the metal alloy is a multiphase alloy having a plurality of chemically distinct phases, and the step of flowing ends after formation of the phases is complete and before the mixture solidifies;
the metal alloy is a multiphase alloy having a first phase and a chemically distinct second phase distributed within the first phase;
the metal alloy has a matrix phase and a chemically distinct particulate phase distributed within the matrix phase;
the metal alloy has an intermetallic compound distributed within a chemically distinct matrix phase;
the metal alloy has particulate phase having an electrical conductivity less than a matrix phase within which the particulate phase is distributed;
the metal alloy has a first phase and a chemically distinct laminar phase distributed within the first phase;
the molten mixture is in contact with each of a pair of separate electrodes during the step of flowing, and both electrodes of the pair are formed from an electrically conductive material, which is optionally non-reactive with the molten mixture;
the molten mixture is in a container during the step of flowing, the method includes transferring the molten mixture to a mold before the molten mixture solidifies to form the metal alloy, and no electric current is flowed through the molten mixture after the step of transferring;
the maximum power density is less than 0.1 W/cm2;
the maximum power density is less than 0.01 W/cm2;
the flow of electric current is continuous;
the metal alloy is an aluminum alloy;
the molten mixture is formed during a welding process; and
the molten mixture is formed during a welding process that includes welding dissimilar metals together to form the molten mixture as a weld pool.

Embodiments of a method of processing a metal alloy include flowing an electric current through a molten mixture including elements of the metal alloy before the molten mixture solidifies to form the metal alloy. The flow of electric current has a maximum power density sufficiently high to produce an average refined feature size of a chemically distinct phase of the metal alloy that is smaller than an average unrefined feature size of the chemically distinct phase when produced in the absence of the electric current flowing through the molten mixture.

The method may further include any technically feasible combination of the above-listed features and the following features:
the maximum power density is sufficiently high to minimize the average refined feature size;
the maximum power density is minimized such that an increase in the maximum power density does not decrease said average refined feature size;
the average refined feature size is 50% or less than the average unrefined feature size; and
the flow of electric current has a maximum power density less than 1 W/cm².

### BRIEF DESCRIPTION OF THE DRAWINGS

FIG. 1 schematically illustrates a method of processing a metal alloy.

FIG. 2 is a schematic cross-sectional view of a container for use in the method of FIG. 1.

FIG. 3 schematically illustrates an example of the method of FIG. 1 in which the molten mixture is formed during a welding process.

FIG. 4 schematically illustrates an example of the method of FIG. 1 in which the molten mixture is formed during a localized remelting process.

FIG. 5 is the cross-section view of FIG. 2 illustrating an example of the method of FIG. 1.

FIG. 6 is an SEM image of an ion beam-polished cross-section of an alloy formed by the method of FIG. 1.

FIG. 7 is an SEM image of an ion beam-polished cross-section of an alloy formed in the absence of the electric current of FIG. 1.

FIG. 8 schematically illustrates an example of the method of FIG. 1 including a remelting process.

FIG. 9 is an SEM image of a cross-section of a metal alloy processed with electric current.

FIG. 10 is an SEM image of a cross-section of a metal alloy having the same composition as the alloy of FIG. 9 but processed without electric current.

FIG. 11 is an SEM image of a cross-section of another metal alloy processed with electric current.

FIG. 12 is an SEM image of a cross-section of a metal alloy having the same composition as the alloy of FIG. 11 but processed without electric current.

### DESCRIPTION OF EMBODIMENTS

Described below is a method of processing a metal alloy in the molten state in a manner that results in a more refined alloy when solidified. The method involves passing an electric current through a mixture of alloy ingredients while in the molten state. The result is an alloy microstructure having feature sizes that are greatly reduced relative to that of the same alloy processed without the influence of the electric current. The amount of electrical energy required to achieve this result is surprisingly low, with an applied current as low as only a few milliamps per square centimeter and a corresponding applied power as low as only a few milliwatts per square centimeter.

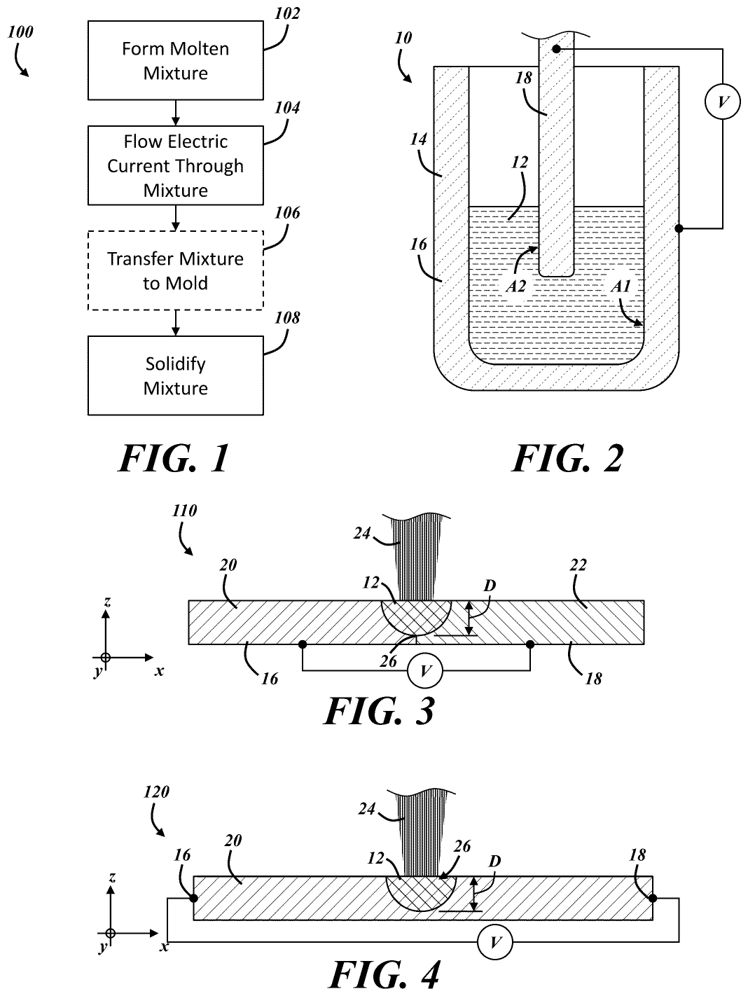

An illustrative method 100 is illustrated in FIG. 1 and may include steps 102-108, respectively including: forming a molten mixture, flowing an electric current through the molten mixture, transferring the molten mixture to a mold, and solidifying the molten mixture to form a metal alloy. The step of transferring 106 is illustrated as optional, as the molten mixture may be solidified in the same container in which the electric current is passed through the mixture.

FIG. 2 is a schematic cross-sectional view of a container 10 for use during step 104 and, optionally, during steps 102 and 108. The container 10 is formed from one or more walls 14, supports the molten mixture 12, and includes at least one electrode 16 positioned to be in direct contact with the molten mixture 12. In this example, the walls 14 of the container 10 define a first electrode 16—i.e., the bottom wall and a tubular side wall are of unitary construction and the electric current flows through the molten mixture via the container walls. The illustrated electrode 16 is in contact with the entire surface area of the molten mixture 12 that is in contact with the container wall(s) 14. In other examples, the electrode 16 is a distinct component from the container walls and is positioned along the inner surface at or near the bottom of the container 10 or along any other portion of the inner surface of the container positioned to contact the molten mixture 12. In some embodiments, the electrode 16 is not part of the container and is simply placed in the container 10 with the molten mixture 12. FIG. 2 also illustrates a central second electrode 18 partly immersed in the molten mixture 12 for use in embodiments of the disclosed methods.

Each electrode 16, 18 may be constructed from an electrically conductive material. As used herein, an electrically conductive material has an electrical conductivity greater than 1000 S/m and may exclude semiconductive metal and/or metalloid oxides. The electrode material may also be selected to be chemically stable at the highest expected temperature of the molten mixture 12, meaning that the material will not melt, deform, or react with elements or compounds of the molten mixture when placed in contact with the mixture. Preferably, all of the electrodes are constructed from an electrically conductive material or a composite of electrically conductive materials to minimize ohmic losses and Joule heating, which can slow the cooling rate of the alloy. Embodiments of the electrodes 16, 18 include or are made from graphite as the electrically conductive material. In the example of FIG. 2, the container 10 and its walls 14 are made from graphite. In other examples, the container walls 14 are made from a non-conductive but chemically stable material (e.g., ceramic) and one or more electrically conductive electrode is located within the walls of the container 10.

To perform step 104 of FIG. 1, the second electrode 18 spaced apart from the first electrode 16 and is placed in contact with the molten mixture 12. A voltage V is applied across the electrodes 16, 18 such that the molten mixture provides a conductive path for the resulting flow of electric current between the electrodes. The voltage V may be a DC voltage or an AC voltage, with RMS values of peak-to-peak AC voltages being equivalent to DC values. The molten mixture 12 is in contact with a portion of the first electrode 16 having a first surface area A1 and with a portion of the second electrode 18 having a second surface area A2. The flow of electric current is characterized by a current density and a power density. Current density is expressed in amperes per unit area, and power density is expressed watts per unit area. The “area” used to determine current or power density is one of the surface areas A1, A2 of the electrodes 16, 18 in contact with the molten mixture 12. When the molten mixture 12 is in contact with more surface area of one electrode than the other, a maximum current density and a maximum power density are defined at the electrode having the smaller surface area in contact with the molten mixture. Likewise, a minimum current density and a minimum power density are defined at the electrode having the larger surface area in contact with the molten mixture.

In the illustrated example, the molten mixture 12 is in contact with a smaller surface area A2 at the second electrode 18 than the surface area A1 at the first electrode 16. Accordingly, the maximum current density and maximum power density are determined using surface area A2. In this example, the first electrode 16 has a circular bottom surface and a surrounding cylindrical surface, and the second electrode 18 is a cylindrical rod. As drawn in FIG. 2 (which is not necessarily to scale), the surfaces area A1 of the first electrode 16 is approximately 12 times larger than the surface area A2 of the second electrode 18, making the maximum current and power densities approximately 12 times larger than the minimum current and power densities for a given applied voltage V.

Embodiments of the method include flowing the electric current through the molten mixture 12 at a maximum power density less than 1 W/cm², which is equivalent to about 80 mW/cm² with the electrode surface area proportions of FIG. 2. The maximum power density may be in a range from 1 mW/cm² to 1.0 W/cm², 1 mW/cm² to 0.5 W/cm², 1 mW/cm² to 0.2 W/cm², 1 mW/cm² to 0.1 W/cm², or 1 mW/cm² to 10 mW/cm². These exceptionally low power densities are contrary to previously known attempts to refine an alloy melt. These power density ranges can be achieved with any combination of voltage and current. For instance, assuming the same electrode surface areas and the same molten mixture, where power density is proportional to the square of the applied voltage, the 1 mW/cm² to 1.0 W/cm² range can be achieved by applying 100 mV to a molten mixture at a current density of 10 mA/cm², on the low end, and increasing the applied voltage to 3.2 V for a current density of 320 mA/cm², on the high end. In some cases, the current density and power density can be tuned via electrode placement. For example, the surface area A2 can be reduced in the set-up of FIG. 2 by moving the second electrode 18 axially away from the molten mixture 12, thereby increasing the effective current density and power density at the second electrode. Generally, since neither voltage nor current density can be increased/decreased without a corresponding increase/decrease in the other, the combinations of voltage and current density are somewhat limited by the particular set-up—i.e., by the resistance of the molten mixture and the electrode surface areas. Sufficient current densities can be as low as 1 mA/cm² or lower, or in a range from 1 mA/cm² to 1 A/cm².

The method is applicable to any metal alloy. A metal alloy is a solid mixture of chemical elements, at least one of which is a metal. A metal alloy may also include at least one non-metallic element. Metal may be the majority constituent of the metal alloy, accounting for more than 50 wt % of the alloy. The metal of the alloy may include any number of metallic elements, where “element” is used in its chemical sense—e.g., iron (Fe) and aluminum (Al) are distinct elements, even when they are covalently bonded to different elements. As used in the context of elemental composition, “majority” means more than 50 wt %. The metal alloy may or may not have a majority element. For example, a 60Sn-40Pb alloy has tin as a majority element, while a 43Sn-43Pb-14Bi alloy has no majority element but has tin and lead as elements present in the greatest amounts. The metal alloy may be a homogeneous alloy made up of a solid solution of metallic elements in a single phase. Or the metal alloy may be a multiphase alloy made up of two or more chemically distinct phases. One phase is chemically distinct from another if it has one or more different elements, a different ratio of the same elements, a different crystalline structure, and/or differently bonded elements than the other. Chemically distinct phases are generally detectable via optical or SEM metallography.

A multiphase alloy may have any number of chemically distinct phases. Each phase may be a pure element, a solid solution of elements, or a chemical compound comprising more than one element of the alloy, such as an intermetallic compound. For purposes of this description, ordinal words (first, second, third, etc.) are used only to distinguish chemically distinct phases from one another and have no other significance unless otherwise specified. For example, a “first phase” is not necessarily formed before a “second phase,” nor is it necessarily present in a greater amount than a “second phase.” A phase that is present in an amount greater than any other phase may be referred to as a “primary phase” with all other phases referred to as “secondary phases.” Some alloys include a “matrix phase” and one or more “particulate phase” distributed within the matrix phase. These terms refer to alloy microstructures in which a secondary particulate phase(s) forms distinct particles or domains within a primary matrix phase. In some multiphase alloys, no phase forms distinct particles or domains within another. For example, an alloy may have a laminar microstructure in which chemically distinct phases are layered together within the alloy. Any phase may be referred to as a “precipitate phase” when it forms within a liquid phase during alloy processing and can be a particulate phase or a laminar phase. A metal alloy may include multiple microstructures as well, such as a laminar matrix phase and a secondary particulate phase distributed throughout the matrix phase.

Referring again to FIG. 1, step 102 of forming the molten mixture 12 may be performed in a variety of ways. Solid elements and/or compounds or alloys including elements of the alloy to be formed may be placed in a container 10 such as that of FIG. 2 and then heated to form the molten mixture 12. The mixture is considered a “molten mixture” when any portion of the mixture is liquid. In this manner of forming the molten mixture, the mixture is considered molten when the component of the mixture with the lowest melting point begins to liquefy. Alternatively, a first material with one or more elements of the alloy may first be made molten or completely liquefied, and a second material with one or more other elements of the alloy can be added to form the molten mixture 12. For instance, a master metal alloy having a relatively high concentration of a particular element may be combined with a molten metal to form an alloy with a relatively low concentration of that element. The order in which materials are liquefied or added to the mixture depends to a large extent on the materials being alloyed. In some cases, the metal alloy to be refined is already made in solid form and is remelted for the electric current refining process. In some cases, the molten mixture 12 is prepared in a different container and then transferred to a container such as that of FIG. 2 for passing electric current through the mixture. In yet other examples, the molten mixture 12 is formed without a container by locally heating and melting (e.g., via laser energy or an electric arc) a pre-existing alloy or heating and melting two different solid materials in contact with each other.

The electric current can be passed through the molten mixture 12 at any time and for any duration, but timing can be important. For a multiphase alloy, the electric current may be passed through the molten mixture 12 during formation of the chemically distinct phases. For example, in a simple binary system that forms a multiphase alloy, the molten mixture 12 may be cooled from a temperature above the liquidus temperature, below which a solid phase begins to form. More of that solid phase may continue to form on further cooling until the mixture is fully solidified. The flow of electric current may be initiated before the solid phase begins to form, and then continue into phase formation, or it may be initiated during phase formation as more of the solid phase is formed. It may be preferable that the electric current is already flowing through the molten mixture 12 when phase formation first begins. This means the electric current is flowing through the molten mixture during the both the nucleation stage and the growth stage of phase crystal formation. Based on experimental results, the presence of the low-power electric current is believed to enhance phase nucleation, which generally results in greater numbers of smaller crystals or grains in each phase and/or smaller feature sizes for each phase. While the exact mechanism is not fully understood and the process is not to be limited by theory, the electric current may inhibit crystal propagation such that nucleation of new crystals is thermodynamically favorable.

This insight to the effect of low-power electric current during alloy phase formation also informs the duration of the electric current application. Embodiments of the method include continuing to flow electric current through the molten mixture until all of the phases associated with the particular elemental composition of the metal alloy are formed or have at least begun to form. For a simple binary system, this may include continuing to flow the electric current through the molten mixture until the mixture solidifies if the amount of solid phase continues to increase with decreasing temperature until that point. For other multiphase alloy systems, all possible solid phases may be formed before the mixture reaches its solidus temperature. In such cases, the flow of electric current may be ceased after all secondary phases have formed and before or at the time the molten mixture solidifies to form the metal alloy since, at that point, the electric current may no longer affect crystal nucleation or growth. In some embodiments, a particular phase or phases associated with a given alloy composition may be a “targeted phase”—meaning that phase is the phase desired to be refined—and the flow of electric current may be halted after the targeted phase is fully formed.

The electric current may be passed through the molten mixture continuously from initiation of current flow to cessation of current flow. Continuous current flow is characterized by a lack of discrete pulses of current flow. Alternatively, the electric current may be passed through the molten mixture in discrete pulses. Discrete pulses may be applied with an effective duty cycle of 25% or greater—that is, the electric current is flowing during at least 25% of each of multiple periodic units of time. In some cases, discrete pulses may have an effective duty cycle greater than 5%. A duty cycle of greater than 75% is considered continuous for purposes of this disclosure.

In embodiments including the step 106 of transferring the molten mixture 12 to a mold, the flow of electric current through the mixture may be halted before or during transference of the mixture to the mold. In some embodiments, no electric current is passed through the molten mixture 12 while the mixture is solidifying in the mold.

Embodiments of the method include flowing the electric current through the molten mixture before phase nucleation begins and continuing to flow the electric current through the mixture at least until the growth stage for at least one phase is completed. In other embodiments, the electric current is flowing when phase nucleation begins and is halted during the growth stage of at least some of the crystals—i.e., the benefits of the electric current may be realized early in the phase growth after a sufficient number of crystal nuclei have formed. The magnitude of the electric current and maximum power density may be sufficiently high to minimize the average feature size of one or more phases of the alloy. The average “feature size” for a particulate phase is an average particle size, and the average feature size for a laminar phase is an average layer thickness. The average feature size for a matrix phase is the average grain size.

A sufficient magnitude for the electric current can be determined experimentally by first establishing a baseline feature size for the targeted phase of an alloy of the desired composition by solidifying the molten mixture 12 with no electric current passing through the mixture. Successive batches of the metal alloy can then be processed as described above, with the maximum power density increased in increments, starting for example at 0.001 W/cm². Standard metallography techniques can be used to evaluate the average feature size of the targeted phase obtained at each power density to identify the power density at which the average feature size plateaus or approaches a limit. This enables identification of a threshold magnitude for the maximum power density. This not only minimizes particle size, but also minimizes power usage so that the molten mixture 12 is not subjected to unnecessarily high power levels.

In some embodiments, the metal alloy is a multiphase alloy including a first phase and a chemically distinct second phase distributed within the first phase. The first phase may be a matrix phase, and the second phase may be a particulate phase. The second phase may include at least two different elements, one of which is also present in the first phase. For example, the first phase may include a first element, and the second phase may include a different second element in solid solution with the first element. Or the second phase may be or may include an intermetallic compound including both of the first and second elements.

In some embodiments, the first phase and the second phase are laminar phases. One laminar phase may be rich in a first element, while the other phase is rich in a second element, where “rich” means there is more of that element than any other element in the phase. One phase may include at least two different elements, one of which is also present in the other phase. For example, the first phase may include a first element, and the second phase may include a different second element in solid solution with the first element. Or the second phase may be or may include an intermetallic compound including both of the first and second elements. Other possible characteristics of the solidified metal alloy are given below.

One phase of the alloy may have an electrical conductivity lower than the electrical conductivity of another phase. For example, a secondary or precipitate phase of the alloy may have an electrical conductivity lower than the electrical conductivity of a primary or matrix phase. The alloy may have a non-lamellar microstructure. The metal alloy may be essentially free from carbon. The metal alloy may be an aluminum alloy with aluminum residing in both a first phase and a second phase. For example, aluminum may be present in a primary or matrix phase and/or in a secondary or particulate phase. The aluminum in one phase may be elemental aluminum, and the aluminum in another phase may be aluminum metal and/or part of an intermetallic compound.

FIG. 3 schematically illustrates an example in which the molten mixture 12 is formed during a welding process 110. In the illustrated example, a first metallic material 20 is being welded to a second metallic material 22 via a laser beam 24 directed along an interface 26 where the two materials abut each other. Each material 20, 22 is a metal or a metal alloy. The molten mixture 12 is in the form of a weld pool that is locally formed where the laser beam 24 impinges the materials 20, 22 and that solidifies as the laser beam moves further along the interface 26 (in the y-direction of FIG. 3). The voltage V may be applied before or at the time the welding is initiated, and the resulting electric current may be passed through the molten mixture 12 during the welding process until the terminal end of the weld pool is solidified. The resulting weld bead is a metal alloy including elements from both materials 20, 22. In this process 110, the electric current is flowing through the molten mixture 12 when nucleation of any phase of the alloy begins and until all phases of the resulting metal alloy, in the form of a weld joint, are formed. In this embodiment, the first material 20 is the first electrode 16 and the second material 22 is the second electrode 18. The corresponding electrode surface areas A1, A2 for determination of maximum power density may be determined as the product of the weld depth D and the length (in the y-direction of FIG. 3) of the intended weld. It is noted that FIG. 3 is a schematic representation of the process in which, for example, the voltage is not necessarily applied along the bottom of the materials 20, 22.

The two materials 20, 22 may be the same material or different materials. For example, both materials 20, 22 may be aluminum alloys having the same chemical composition. In this case, the method can refine the materials such that the resulting alloy at the weld joint has a targeted phase of which the average feature size has been maintained or reduced relative to its size in the two materials 20, 22 prior to welding.

In a specific example, the respective materials 20, 22 are an aluminum-based and an iron-based material, such as an aluminum alloy and a steel alloy. Although steel-aluminum welding has become relatively common in some industries, such as automotive, achieving sufficient joint strength is a continual challenge due to the presence of Al—Fe intermetallic compounds, which can cause major problems if left to their own devices. Attempts have been made to combat the effect of Al—Fe intermetallics in weld joints, such as adding other metals to the weld pool to change and/or control the types of phases that are formed in the weld joint. According to the above-described method, the average feature size of intermetallic phases formed in the weld joint can be reduced and/or minimized by passing electric current through the molten mixture of aluminum alloy and steel during welding.

FIG. 4 schematically illustrates an example in which the molten mixture 12 is formed during a localized remelting process 120. Here, a laser beam 24 with sufficient power is directed toward a surface of a metal or metal alloy 20 along a melting path 26 extending in the y-direction. Except where constituents of an alloy are burned off by the laser beam 24, the molten mixture 12 has the same elemental composition as the base material 20 and solidifies as the laser beam moves further along the melting path 26. The voltage V may be applied before or at the time the melting is initiated, and the resulting electric current may be passed through the molten mixture 12 during the remelting process until the material resolidifies at the terminal end of the melting path 26. The result along the melting path is a refined alloy with the same composition as the base material 20 but with a microstructure having reduced average features sizes. In this process 120, the electric current is flowing through the molten mixture 12 when nucleation of any phase of the alloy begins and until all phases of the alloy are reformed. In this example, opposite ends of the material 20 serves as the electrodes 16, 18. The corresponding electrode surface areas A1, A2 for determination of maximum power density may be determined as the product of the penetration depth D and the length (in the y-direction) of the melting path 26. The process 120 is useful to locally reduce the average feature size of phases, such as intermetallic compound phases, of an already produced alloy 20. For example, a subsequent process may include bending the material 20 in a metal forming operation, and the melting path 26 may be defined along the intended bend.

Metal alloys have been produced and characterized consistent with the above-described methods. For purposes of the experiments, binary metal alloys were used to limit the complexities associated with additional alloying elements for purposes of evaluating the effect of a low-power density electric current on phase formation as described below.

### Experimental Example 1

A binary multiphase alloy comprising aluminum (Al) and titanium (Ti) was produced consistent with the above-described methods. The targeted alloy composition was Al-3Ti (i.e., 97 wt % Al, 3 wt % Ti). According to the phase diagram for the Al—Ti system at this composition, an Al₃Ti intermetallic precipitate phase forms in liquid aluminum below the liquidus temperature (˜1025° C.) and above the solidus temperature (˜665° C.) of the alloy. Al₃Ti can form with different morphologies based on local composition and temperature, including a high aspect ratio plate-like morphology and a low aspect ratio block-like morphology. The block-like morphology is generally preferred so that the largest dimension of the particles can be minimized.

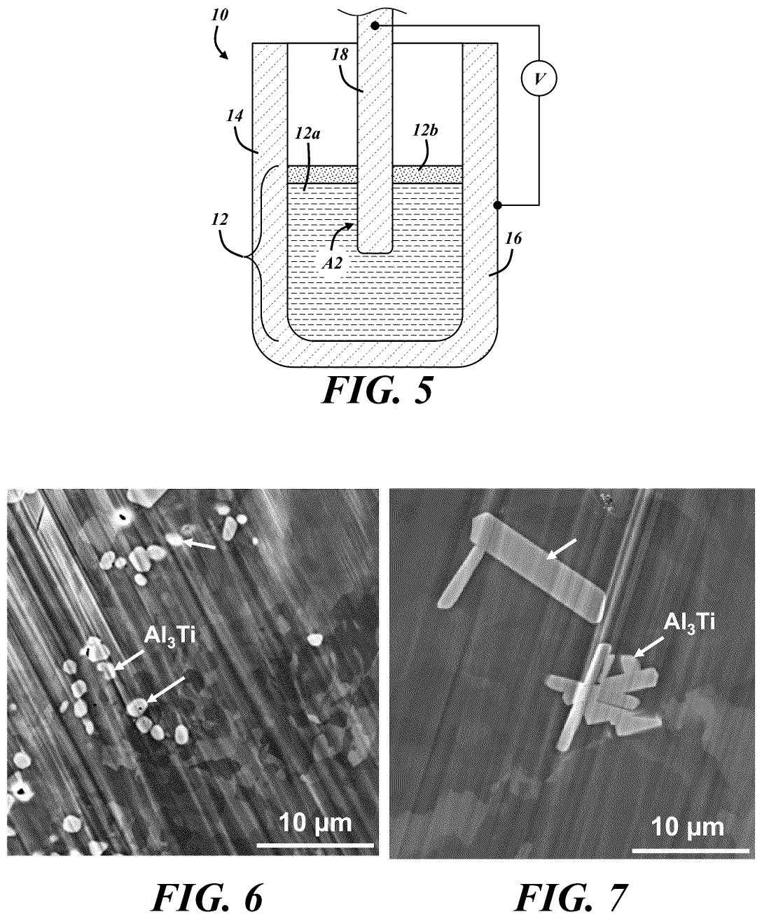

With reference to FIG. 5, the molten mixture 12 was formed in a graphite crucible that doubled as the container 10 and the first electrode 16, as in FIG. 2. The second electrode 18 was a ¼″ diameter graphite rod with its distal end in the molten mixture 12. Aluminum metal 12a was placed in the crucible 10 and heated to 750° C., which is above the melting point of aluminum, but below the liquidus temperature of Al-3Ti. Once the aluminum was liquefied, a Ti-containing flux 12b was disposed on top of the molten aluminum 12a. The flux 12b used in this case was a K₂TiF₆ flux, and the amount of flux was calculated to arrive at the targeted Al-3Ti composition. The flux 12b required 2-3 minutes to fully melt at the 750° C. temperature of the molten aluminum. The flux 12b reacts with the aluminum at the surface of the melt, and this reaction results in excess titanium going into solution briefly in the aluminum before forming the intermetallic compound Al₃Ti.

The flow of electric current was initiated simultaneously with the addition of the flux 12b atop the molten aluminum. In this manner, the presence of the electric current was ensured at the nucleation stage of the Al₃Ti phase. 20 mA of AC current was passed through the molten mixture for about 5 minutes via application of 600 mV across the electrodes 16, 18. Maximum current density—i.e., the current density at the surface of the smaller electrode 18—was about 3 mA/cm², making the maximum power density about 2 mW/cm². The molten mixture 12 was then poured into a rectangular graphite mold and allowed to solidify and cool. Metallography samples were prepared from the molded metal alloy.

FIG. 6 is an SEM image of an ion beam-polished cross-section of the resulting alloy. Several particles of the intermetallic Al₃Ti phase are shown dispersed in the aluminum matrix phase. Some of the Al₃Ti particles have arrows pointing at them in FIG. 6. The average feature size of this particulate phase is on the order of 1 μm.

For purposes of comparison, FIG. 7 is an SEM image of an ion beam-polished cross-section of the same alloy prepared without passing electric current through the molten mixture during phase formation. Some of the Al₃Ti particles have arrows pointing at them in FIG. 7. The average feature size of this particulate phase is on the order of 10-15 μm.

### Experimental Example 2

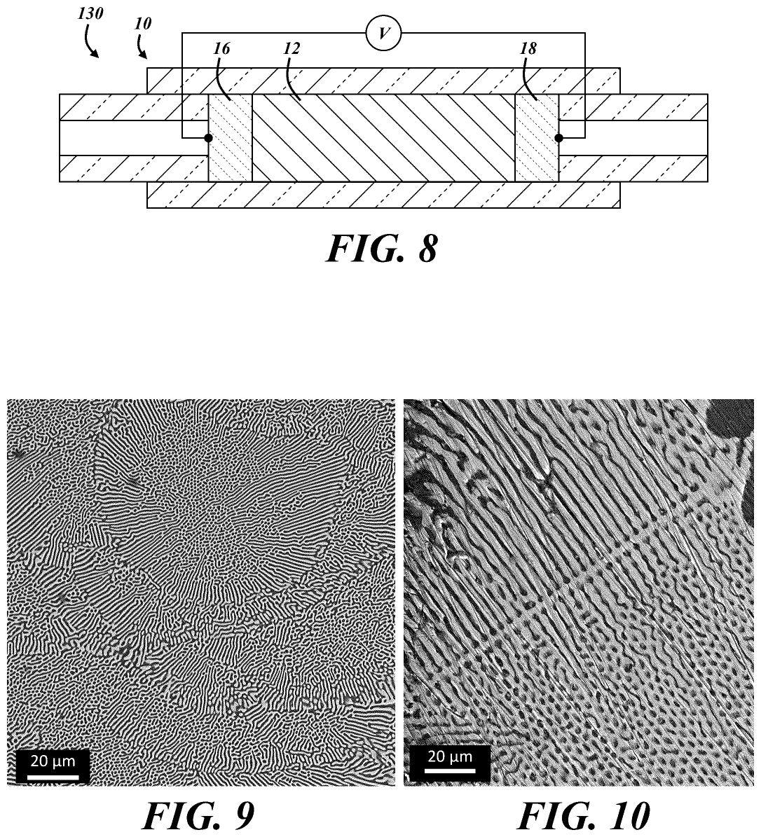

A binary multiphase alloy comprising aluminum (Al) and copper (Cu) was processed consistent with the above-described methods. The alloy composition was a eutectic composition including 32.7 wt % Cu, which has a eutectic melting point at 548° C. At this composition, chemically distinct first and second laminar phases form during solidification, including an aluminum phase and an intermetallic Al₂Cu phase. FIG. 8 schematically illustrates a remelting process 130 in which the molten mixture 12 was formed in an alumina tube with a 6 mm inner diameter as the container 10. A pre-existing sample of the Al—Cu alloy was placed in the alumina tube 10 with graphite electrodes 16, 18 at opposite ends of the alloy and in contact with the alloy. This container 10 was then placed in a tube furnace for temperature cycling. The sample was heated to 750° C. and held at that temperature for 30 minutes to form the molten mixture 12, and then the molten mixture was allowed to cool and solidify in the furnace 10.

The flow of electric current was initiated during cooling and before the molten mixture 12 reached its eutectic melting point and flowed through the molten mixture until fully solidified. In this manner, the presence of the electric current was ensured at the nucleation stage of both of the phases. An AC voltage of 400 mV was applied across the electrodes 16, 18 at a current density of 25 mA/cm², making the maximum power density 10 mW/cm². For purposes of comparison, the remelting and solidification process was repeated without passing electric current through the molten mixture.

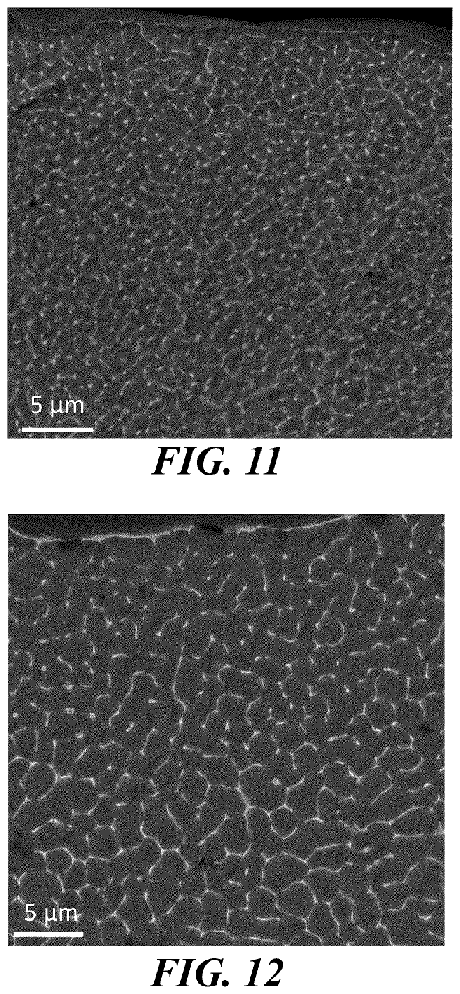

FIG. 9 is an SEM image of a representative cross-section of the resulting alloy processed with electric current, and FIG. 10 is an SEM image of a representative cross-section of the alloy processed without electric current at approximately the same magnification as FIG. 9. The light-colored phase in the images is the primary intermetallic Al₂Cu phase, and the dark-colored phase is the aluminum phase. Qualitatively, it is apparent that the sample processed using electric current (FIG. 9) has a more refined microstructure than the sample processed without electric current (FIG. 10). The average feature size in the microstructure of FIG. 9 is on the order of 1 μm, while the average feature size in the microstructure of FIG. 10 is on the order of 3-5 μm.

### Experimental Example 3

A binary multiphase alloy comprising aluminum (Al) and copper (Cu) was processed consistent with the above-described methods. The alloy was an Al-10Cu alloy comprising 10 wt % copper. At this composition, chemically distinct first and second phases form during solidification, including an aluminum matrix phase and a laminar intermetallic Al₂Cu phase with layers distributed within the matrix phase. In this example, the laser remelting process 120 of FIG. 4 was employed, and the material had a thickness of 1.38 cm and a length (in the y-direction of FIG. 4) of 5.08 cm for a cross-sectional area of 7.01 cm2. The laser beam 24 was produced using a 1400 W laser and had a beam diameter of 1.5 mm. The depth D of the molten mixture 12 was approximately 250-300 μm, based on post-process analysis.

The flow of electric current was initiated simultaneously with the laser remelting and ceased when the terminal end of the remelted alloy solidified. In this manner, the presence of the electric current was ensured at the nucleation stage of both of the phases. A DC voltage of 5 V was applied across the electrodes 16, 18 at a current density of 27 mA/cm², making the maximum power density 135 mW/cm². For purposes of comparison, the remelting and solidification process was also performed without passing electric current through the material. Metallography samples were prepared from cross-sections taken perpendicular to the direction of laser beam movement (along the x-z plane of FIG. 4).

FIG. 11 is an SEM image of a representative cross-section of the resulting alloy processed with electric current, and FIG. 12 is an SEM image of a representative cross-section of the alloy processed without electric current at approximately the same magnification as FIG. 11. The light-colored phase in the images is the laminar intermetallic Al₂Cu phase, and the dark-colored phase is the aluminum matrix phase. Qualitatively, it is apparent that the sample processed using electric current (FIG. 11) has a more refined microstructure than the sample processed without electric current (FIG. 12). The average feature size (spacing between the layers of the laminar phase) in the microstructure of FIG. 11 is about 50% of the average feature size in the microstructure of FIG. 12.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of processing a metal alloy, comprising:
flowing an electric current through a molten mixture comprising elements of the metal alloy before the molten mixture solidifies to form the metal alloy, wherein the flow of electric current has a maximum power density less than 1 W/cm².

2. The method of claim 1, wherein the metal alloy is a multiphase alloy having a plurality of chemically distinct phases, and the step of flowing is performed during formation of the phases.

3. The method of claim 1, wherein the metal alloy is a multiphase alloy having a plurality of chemically distinct phases, and the step of flowing is performed before formation of the phases and continues during formation of the phases.

4. The method of claim 1, wherein the metal alloy is a multiphase alloy having a plurality of chemically distinct phases, and the step of flowing ends after formation of the phases is complete and before the mixture solidifies.

5. The method of claim 1, wherein the metal alloy is a multiphase alloy having a first phase and a chemically distinct second phase distributed within the first phase.

6. The method of claim 5, wherein the first phase is a matrix phase and the second phase is a particulate phase.

7. The method of claim 6, wherein the particulate phase is an intermetallic compound.

8. The method of claim 6, wherein the particulate phase has an electrical conductivity less than an electrical conductivity of the matrix phase.

9. The method of claim 5, wherein at least the second phase is a laminar phase.

10. The method of claim 1, wherein the molten mixture is in contact with each of a pair of separate electrodes during the step of flowing, and both electrodes of the pair are formed from an electrically conductive material.

11. The method of claim 10, wherein the electrically conductive material is non-reactive with the molten mixture.

12. The method of claim 1, wherein the molten mixture is in a container during the step of flowing, the method further comprising transferring the molten mixture to a mold before the molten mixture solidifies to form the metal alloy, wherein no electric current is flowed through the molten mixture after the step of transferring.

13. The method of claim 1, wherein the maximum power density is less than 0.1 W/cm².

14. The method of claim 1, wherein the maximum power density is less than 0.01 W/cm².

15. The method of claim 1, wherein the flow of electric current is continuous.

16. The method of claim 1, wherein the metal alloy is an aluminum alloy.

17. The method of claim 1, wherein the molten mixture is formed during a welding process.

18. The method of claim 16, wherein the welding process includes welding dissimilar metals together to form the molten mixture as a weld pool.

19. A method of processing a metal alloy, comprising:
flowing an electric current through a molten mixture comprising elements of the metal alloy before the molten mixture solidifies to form the metal alloy, wherein the flow of electric current has a maximum power density sufficiently high to produce an average refined feature size of a chemically distinct phase of the metal alloy that is smaller than an average unrefined feature size of the chemically distinct phase produced in the absence of the electric current flowing through the molten mixture.

20. The method of claim 19, wherein the maximum power density is sufficiently high to minimize said average refined feature size.

21. The method of claim 20, wherein the maximum power density is minimized such that an increase in the maximum power density does not decrease said average refined feature size.

22. The method of claim 19, wherein the average refined feature size is 50% or less than the average unrefined feature size.

23. The method of claim 19, wherein the flow of electric current has a maximum power density less than 1 W/cm².
